(19) United States
(12) Patent Application Publication
(10) Pub. No.: US 2009/0051475 A1
(43) Pub. Date: Feb. 26, 2009

(54) EMBEDDED INDUCTOR AND MANUFACTURING METHOD THEREOF

(76) Inventors: Yu-Lin Hsueh, Taoyuan Hsien (TW); Cheng-Hong Lee, Taoyuan Hsien (TW); Yi-Hong Huang, Taoyuan Hsien (TW); Li Chang, Taoyuan Hsien (TW)

Correspondence Address: Muncy, Geissler, Olds & Lowe, PLLC, P.O. BOX 1364, FAIRFAX, VA, 22038-1364, US

(21) Appl. No.: 12/195,775

(22) Filed: Aug. 21, 2008

(30) Foreign Application Priority Data
Aug. 24, 2007 (TW) 096131435

(51) Int. Cl. H01F 27/02; H01F 7/06

(52) U.S. Cl. 336/83; 29/606

(57) ABSTRACT

An embedded inductor includes a coil and a magnetic body covering the coil. The magnetic body includes an insulated magnetic powder, a coupling agent and a resin. In addition, a manufacturing method of the embedded inductor includes steps of performing an insulation process for a magnetic powder to obtain an insulated magnetic powder; performing a surface process on the insulated magnetic powder; mixing the surface-processed insulated magnetic powder with a liquid resin to form a mixture; providing a coil; covering the coil with the mixture; and performing pressing and curing processes to obtain the embedded inductor.

### CROSS REFERENCE TO RELATED APPLICATIONS

This Non-provisional application claims priority under 35 U.S.C. §119(a) on Patent Application No(s). 096131435 filed in Taiwan, Republic of China on Aug. 24, 2007, the entire contents of which are hereby incorporated by reference.

### BACKGROUND OF THE INVENTION

1. Field of Invention

The invention relates to an embedded inductor and the manufacturing thereof.

2. Related Art

In the development of electronic products, basic and important elements such as inductors play very important roles. Therefore, how to make high-quality inductors is one goal of the field. In view of the miniaturization trend, embedded inductors are introduced.

The production method for a conventional embedded inductor is mostly dry processes. Magnetic powder and resin are mixed in a dry way before they are molded by thermal compression. Since there insufficient adhesive force between them, the resin often cannot be uniformly distributed on the magnetic powder surface during the stirring process. The inductance and performance (e.g., induced charge) of the conventional inductor may be affected due to cracks in the subsequent resin curing process. Besides, the resin curing process requires a larger molding pressure. This increases electrical power use and reduces the lifetime of molding tools. These drawbacks call for improvements in conventional inductors.

Therefore, it is an important subject to provide an inductor and a manufacturing method thereof that can fully mix the magnetic material and resin.

### SUMMARY OF THE INVENTION

In view of the foregoing, the invention is to provide an embedded inductor and the manufacturing method thereof that can fully mix the magnetic material and resin to ensure the stability in the inductance and performance. In addition, the manufacturing method of the inductor of the invention does not require a high molding pressure and thus can elongate the lifetime of molding tools.

To achieve the above, the invention discloses a manufacturing method of an embedded inductor. The method includes the steps of: performing an insulation process for a magnetic powder to obtain an insulated magnetic powder; performing a surface process on the insulated magnetic powder; mixing the surface-processed insulated magnetic powder with a liquid resin to form a mixture; providing a coil; covering the coil with the mixture; and performing pressing and curing processes to obtain the embedded inductor.

To achieve the above, the invention also discloses an embedded inductor including a coil and a magnetic body covering the coil. The magnetic body includes an insulated magnetic powder, a coupling agent and a resin.

As mentioned above, the embedded inductor and the manufacturing method of the invention utilize a wet process. An insulated magnetic power is coated by a coupling agent and then mixed with a liquid resin. In comparison with the prior art, the surface-processed magnetic powder of the present invention achieves an improved insulation effect. In addition, it can reduce the amount of organic solvent when mixed with the resin, but increases the bonding force with the liquid resin so that the surface of the insulated magnetic powder can be uniformly coated by the liquid resin. This ensures the stability in inductance and performance. The inductor formed by warm pressing or hot pressing is less likely to have cracks. Because of the uniform coat of the liquid resin over the insulated magnetic powder, the output pressure during molding is stable and no high molding pressure is required. This can elongate the lifetime of molding tools.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a flowchart of the manufacturing method of an embedded inductor according to an embodiment of the present invention;

FIGS. 2A and 2B are schematic views of the manufacturing method in FIG. 1; and

FIG. 3 is a schematic view of an embedded inductor according to the embodiment of the present invention.

### DETAILED DESCRIPTION OF THE INVENTION

The present invention will be apparent from the following detailed description, which proceeds with reference to the accompanying drawings, wherein the same references relate to the same elements.

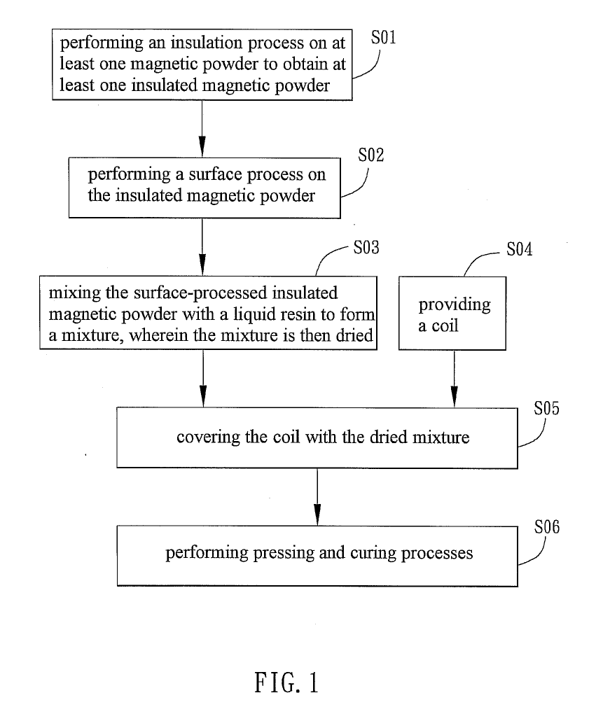

Referring to FIG. 1, a manufacturing method of an embedded inductor includes steps S01 to S06. In step S01, an insulation process is performed on a magnetic powder to obtain an insulated magnetic powder. The magnetic powder includes, for example but not limited to, iron (Fe), cobalt (Co), nickel (Ni) or their alloys. The average diameter of the magnetic powder is about 1 to 100 micron (μm). In the insulation process, the magnetic powder is coated by an inorganic material. The inorganic material includes, for example but not limited to, phosphate or a ceramic material. The ceramic material includes, for example but not limited to, aluminum oxide or zinc oxide.

In step S02, the insulated magnetic powder is processed with a surface process. The surface process utilizes a coupling agent to coat the insulated magnetic powder. The amount of the coupling agent is about 0.5% to 6% of the magnetic powder in weight. The coupling agent is fully mixed with an organic solvent (e.g., acetone) into a solution A. Then, the insulated magnetic powder is added into the solution A for full mixing, followed by a drying process.

The coupling agent includes, for example but not limited to, a surface modifier or a surfactant. The surface modifier is, for example, organic silyl, titanium-based, aluminum-based or zirconium-based compound. The surfactant is, for example, perfluoroalkyl or lauryldimethylamine oxide.

In step S03, the surface-processed insulated magnetic powder is mixed with a liquid resin. The amount of the liquid resin is 1% to 6% of the magnetic powder in weight. The liquid resin is fully mixed with an organic solvent (e.g., acetone) to form a solution B. Then, the surface-processed insulated magnetic powder is added into the solution B for full mixing, followed by a drying process to obtain a mixture. Besides, an additional step follows step S03. The additional step is to mix the mixture with a lubricant to form a compound magnetic powder. The amount of the lubricant is 0.05% to 1% of the magnetic powder in weight. The lubricant includes, for example but not limited to, stearic acids, wax or graphite. The liquid resin is, for example, a thermosetting resin.

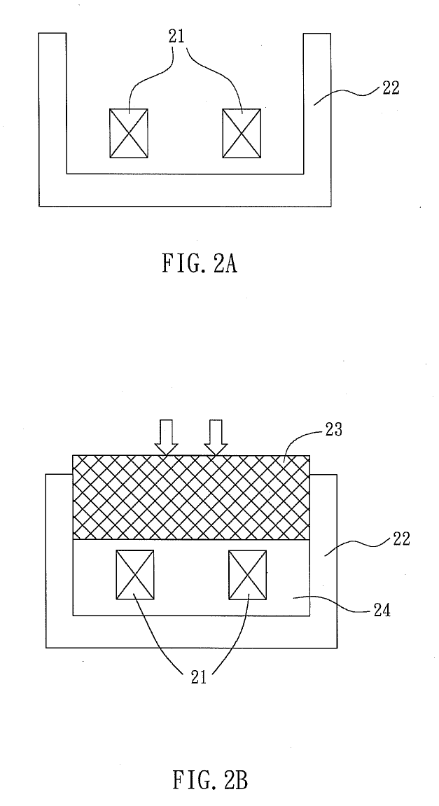

With reference to FIGS. 1 and 2A, step S04 is to provide a coil 21 that is disposed in a mold 22.

With reference to FIGS. 1 and 2B, step S05 is to fill the above-mentioned compound magnetic powder into the mold 22 to cover the coil 21. In step S06, the compound magnetic powder is cured by warm or hot pressing, which is performed with an upper mold 23. This completes the process of making an embedded inductor. Alternatively, the compound magnetic powder can be pre-pressed into a magnetic body with EE or EI profile. Afterwards, a coil is disposed inside the magnetic body. Finally, they are pressed to form an embedded inductor.

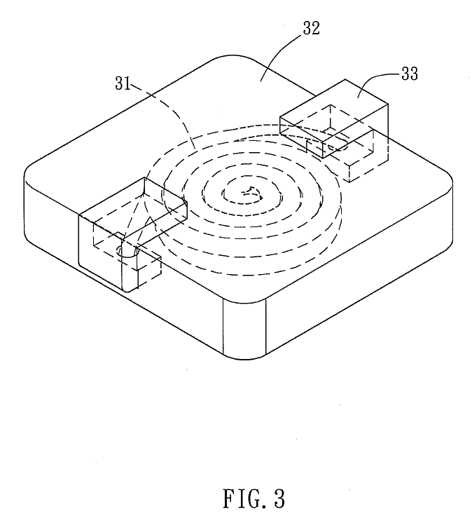

As shown in FIG. 3, the embedded inductor according to an embodiment of the present invention includes a coil 31, two terminals 33 and a magnetic body 32. The terminals 33 are connected to both ends of the coil 31, respectively. The magnetic body 32 covers the coil 31, and the terminals 33 are exposed without covered by the magnetic body 32. The magnetic body 32 includes an insulated magnetic powder, a coupling agent and a resin. Since the embedded inductor and the manufacturing method thereof have been described before, the detailed descriptions thereof are omitted. Besides, both ends of the coil 31 can be directly extended outside the magnetic body as the terminals.

In summary, the embedded inductor and the manufacturing method of the invention utilize a wet process. An insulated magnetic powder is covered by a coupling agent and then mixed with a liquid resin. In comparison with the prior art, the surface-processed magnetic powder of the present invention also achieves the insulation effect. In addition, it can reduce the amount of organic solvent when mixed with the resin, but increases the bonding force with the liquid resin so that the surface of the insulated magnetic powder can be uniformly covered by the liquid resin. This ensures the stability in inductance and performance. The inductor formed by warm pressing or hot pressing is less likely to have cracks. Because of the uniform coverage of the liquid resin over the insulated magnetic powder, the output pressure during molding is stable and no high molding pressure is required. This can elongate the lifetime of molding tools.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A manufacturing method of an embedded inductor, comprising steps of:
performing an insulation process for a magnetic powder to obtain an insulated magnetic powder;
performing a surface process on the insulated magnetic powder;
mixing the surface-processed insulated magnetic powder with a liquid resin to form a mixture;
providing a coil;
covering the coil with the mixture; and
performing pressing and curing processes to obtain the embedded inductor.

2. The manufacturing method of claim 1, wherein the magnetic powder is iron, cobalt, nickel or alloy thereof, and the average diameter of the magnetic powder is 1 to 100 microns.

3. The manufacturing method of claim 1, wherein the insulation processing step is performed by covering the magnetic powder with an inorganic material.

4. The manufacturing method of claim 3, wherein the inorganic material comprises phosphoric acid, a ceramic material, aluminum oxide or zinc oxide.

5. The manufacturing method of claim 1, wherein the surface processing step is performed by covering the insulated magnetic powder with a coupling agent, and the coupling agent is 0.5% to 6% of the magnetic powder in weight.

6. The manufacturing method of claim 5 further comprising steps of:
mixing the coupling agent with an organic solvent; and
adding the insulated magnetic powder for mixing and drying.

7. The manufacturing method of claim 5, wherein the coupling agent is a surface modifier comprising organic silyl, titanium-based, aluminum-based, zirconium-based compound, or a surfactant comprising perfluoroalkyl or lauryldimethylamine oxide.

8. The manufacturing method of claim 1, wherein the liquid resin is 1% to 6% of the magnetic powder in weight.

9. The manufacturing method of claim 1 further comprising steps of:
mixing the liquid resin with an organic solvent; and
adding the surface-processed insulated magnetic powder for mixing and drying.

10. The manufacturing method of claim 1, wherein after the step of covering the coil with the mixture, the method further comprises steps of:
drying the mixture of the surface-processed insulated magnetic powder and the liquid resin; and
adding a lubricant and mixing to obtain a compound magnetic powder.

11. The manufacturing method of claim 10, wherein the lubricant is 0.05% to 1% of the magnetic powder in weight, and the lubricant comprises stearic acid, wax, or graphite.

12. The manufacturing method of claim 1, wherein before the step of covering the coil with the mixture, the method further comprises steps of:
pre-pressing the mixture into a magnetic body of a particular shape; and
covering the coil inside the magnetic body.

13. An embedded inductor, comprising:
a coil; and
a magnetic body covering the coil and comprising an insulated magnetic powder, a coupling agent and a resin.

14. The embedded inductor of claim 13, wherein the insulated magnetic powder is formed by covering at least one magnetic powder with an inorganic material.

15. The embedded inductor of claim 14, wherein the average diameter of the magnetic powder is 1 to 100 microns.

16. The embedded inductor of claim 14, wherein the magnetic powder is iron, cobalt, nickel or alloy thereof, and the inorganic material comprises phosphoric acid, ceramic material, aluminum oxide or zinc oxide.

17. The embedded inductor of claim 14, wherein the coupling agent is 0.5% to 6% of the magnetic powder in weight.

18. The embedded inductor of claim 14, wherein the magnetic body further comprises a lubricant, wherein the lubricant is 0.05% to 1% of the magnetic powder in weight and comprises stearic acid, wax, or graphite.

19. The embedded inductor of claim 13, wherein the resin is 1% to 6% of the magnetic powder in weight.

20. The embedded inductor of claim 13, wherein two ends of the coil extend outside the magnetic body as terminals.

21. The embedded inductor of claim 13 further comprising two terminals connected to both ends of the coil.
